(19) United States
(12) Patent Application Publication
(10) Pub. No.: US 2026/0129594 A1
(43) Pub. Date: May 7, 2026

(54) SECONDARY SYNCHRONIZATION SIGNAL CONSTRUCTIONS FOR SYNCHRONIZATION SIGNAL BLOCKS

(71) Applicant: Lenovo (United States) Inc., Morrisville, NC (US)

(72) Inventors: Karthikeyan GANESAN, Nauheim (DE); Ali Ramadan ALI, Kraiburg am Inn (DE); Ravi KUCHIBHOTLA, Chicago, IL (US)

(21) Appl. No.: 19/440,417

(22) Filed: Jan. 5, 2026

(51) Int. Cl. H04W 56/00; H04L 27/26

(52) U.S. Cl. CPC H04W 56/001; H04L 27/26

(57) ABSTRACT

Various aspects of the present disclosure relate to an enhanced synchronization signal block (SSB) structure or design for 6G radio access technologies and other access technologies. For example, the present disclosure introduces SSBs that carry secondary synchronization signals SSSs constructed using complementary Golay pairs. A transmitter may generate multiple Golay sequences and map the sequences to the SSS symbols of the SSBs. For adjacent SSSs, the Golay sequences may be complementary Golay pairs, where there is a base Golay sequence and a complementary Golay sequence that results in a periodic or an aperiodic autocorrelation sum being zero (or close to zero), among other criteria.

### TECHNICAL FIELD

The present disclosure relates to wireless communications, and more specifically to the design of synchronization signal blocks (SSBs), such as various secondary synchronization signal (SSS) structures for SSBs.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support XL MIMO technologies, such as large-scale deployments (1000+) of antenna elements, which can improve the capacity of the network, data rates, and spectral efficiency. For example, 6G radio access technologies may include an antenna element configuration of 5000 or more antenna elements in an upper mid-band frequency (e.g., 7 to 24 GHz).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to provide enhanced designs of SSBs, such as various enhanced SSS structures for SSBs.

A network entity for wireless communication is described. The network entity may be configured to, capable of, or operable to perform one or more operations as described herein. For example, the network entity may comprise at least one memory and at least one processor coupled with the at least one memory and configured to cause the network entity to generate multiple SSSs constructed from a complementary Golay sequence pair, map the complementary Golay sequence pair to orthogonal frequency-division multiplexing (OFDM) symbols allocated for the SSSs, and transmit an SSB that includes OFDM symbols allocated for primary synchronization signals (PSSs), OFDM symbols allocated for a physical broadcast channel (PBCH), and the OFDM symbols allocated for the SSSs.

A method performed or performable by the network entity is described. The method may comprise generating multiple SSSs constructed from a complementary Golay sequence pair, map the complementary Golay sequence pair to OFDM symbols allocated for the SSSs, and transmit an SSB that includes OFDM symbols allocated for PSS symbols, OFDM symbols allocated for PBHH, and the OFDM symbols allocated for the SSSs.

In some implementations of the network entity and method described herein, the complementary Golay sequence pair includes a base Golay sequence mapped to an OFDM symbol allocated for a first SSS and a complementary Golay sequence mapped to an OFDM symbol allocated for a second SSS.

In some implementations of the network entity and method described herein, the OFDM symbol allocated for the first SSS is a fourth symbol of the SSB and the OFDM symbol allocated for the second SSS is a fifth symbol of the SSB.

In some implementations of the network entity and method described herein, the OFDM symbol allocated for the first SSS is a fourth symbol of the SSB and the OFDM symbol allocated for the second SSS is a sixth symbol of the SSB.

In some implementations of the network entity and method described herein, the complementary Golay sequence pair includes a first Golay sequence and a second Golay sequence having a periodic or an aperiodic auto correlation that is zero or close to zero.

In some implementations of the network entity and method described herein, the complementary Golay sequence pair includes a first Golay sequence and a second Golay sequence that satisfy a complementary check using cyclic shifts.

In some implementations of the network entity and method described herein, the complementary Golay sequence pair is a linear combinatorial of a base Golay sequence and complementary Golay sequence.

In some implementations of the network entity and method described herein, the complementary Golay sequence pair is generated using cyclic shifts.

In some implementations of the network entity and method described herein, the complementary Golay sequence pair is generated using sign flips or sign reversals.

In some implementations of the network entity and method described herein, the complementary Golay sequence pair is generated using convolution with Barker sequences.

In some implementations of the network entity and method described herein, the complementary Golay sequence pair is generated using concatenations.

In some implementations of the network entity and method described herein, the complementary Golay sequence pair is generated using a Prouhet-Thue-Morse (PTM) construction.

In some implementations of the network entity and method described herein, the complementary Golay sequence pair is generated using Hadamard matrix transformations.

A UE for wireless communication is described. The UE may be configured to, capable of, or operable to perform one or more operations as described herein. For example, the UE may comprise at least one memory and at least one processor coupled with the at least one memory and configured to cause the UE to receive an SSB that includes OFDM symbols allocated for PSSs, OFDM symbols allocated for SSSs, and OFDM symbols allocated for PBCH, wherein the SSSs are constructed from a complementary Golay sequence pair and detect a first SSS and a second SSS from the complementary Golay sequence pair.

A processor for wireless communication is described. The processor may be configured to, capable of, or operable to perform one or more operations as described herein. For example, the processor may comprise at least one memory and at least one controller coupled with the at least one memory and configured to cause the processor to receive an SSB that includes OFDM symbols allocated for PSSs, OFDM symbols allocated for SSSs, and OFDM symbols allocated for PBCH, wherein the SSSs are constructed from a complementary Golay sequence pair and detect a first SSS and a second SSS from the complementary Golay sequence pair.

A method performed or performable by the UE is described. The method may comprise receiving an SSB that includes OFDM symbols allocated for PSSs, OFDM symbols allocated for SSSs, and OFDM symbols allocated for PBCH, wherein the SSSs are constructed from a complementary Golay sequence pair and detecting a first SSS and a second SSS from the complementary Golay sequence pair.

In some implementations of the UE, processor, and method described herein, a base Golay sequence is mapped to an OFDM symbol allocated for the first SSS and a complementary Golay sequence is mapped to an OFDM symbol allocated for a second SSS.

In some implementations of the UE, processor, and method described herein, the OFDM symbol allocated for the first SSS is a fourth symbol of the SSB and the OFDM symbol allocated for the second SSS is a fifth symbol of the SSB.

In some implementations of the UE, processor, and method described herein, the OFDM symbol allocated for the first SSS is a fourth symbol of the SSB and the OFDM symbol allocated for the second SSS is a sixth symbol of the SSB.

In some implementations of the UE, processor, and method described herein, the complementary Golay sequence pair includes a first Golay sequence and a second Golay sequence having a periodic or an aperiodic auto correlation that is zero or close to zero.

### BRIEF DESCRIPTION OF THE DRAWINGS

FIG. 1 illustrates an example of a wireless communications system in accordance with aspects of the present disclosure.

FIG. 2 illustrates an example of an SSB structure in accordance with aspects of the present disclosure.

FIG. 3 illustrates another example of an SSB structure in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by an NE in accordance with aspects of the present disclosure.

FIG. 8 illustrates a flowchart of a method performed by a UE in accordance with aspects of the present disclosure.

### DETAILED DESCRIPTION

During cell search operations, a UE receives and utilizes synchronization signals from a cell (e.g., a base station or other network entity) to determine information that enables the UE to access the cell. For example, the cell may transmit SSBs every 5 milliseconds or with other periodicities (e.g., 5 ms, 10 ms, 20 ms, and so on). To provide for coverage over an entire cell area, the cell may perform beam sweeping. Beam sweeping entails communication of one or more cell defining SSB bursts (or burst sets), where each SSB burst includes a set of SSBs, and where each SSB may be transmitted by a different or separate beam.

Often, an SSB, or SS/PBCH block structure, may contain multiple PSS and/or SSS symbols, such as pairs of PSS/SSS symbols. When certain sequences are used to generate the synchronization symbols (e.g., m-sequences or gold sequences), certain issues may arise with respect to cross-correlation between adjacent symbols, such as high off-peak cross-correlations, resulting in false alarms between paired signals. For example, a receiver may incorrectly or erroneously identify a non-target synchronization signal instead of a target synchronization signal, which can result in an erroneous physical cell ID detection.

Thus, SSBs having SSs (e.g., SSSs) constructed from sequences that realize off peak cross-correlations may enhance the detection and synchronization of a UE with a cell or other NEs.

The present disclosure introduces SSBs that carry SSSs constructed using complementary Golay pairs. For example, the NE may generate multiple Golay sequences and map the sequences to the SSS symbols of the SSBs. For adjacent SSSs, the Golay sequences may be complementary Golay pairs, where there is a base Golay sequence and a complementary Golay sequence that results in a periodic or an aperiodic autocorrelation sum being zero (or close to zero).

The NE may utilize various techniques when generating Golay pairs, such as cyclic shifts, sign flips or sign reversals, convolutions, concatenations, Prouhet-Thue-Morse (PTM) constructions, Hadamard matrix transformations, and so on. Thus, the NE may implement the construction of SSSs from Golay sequence pairs using a variety of techniques, enabling the NE to generate SSBs that exhibit low cross-correlation between symbols and improved SSB reception and detection, among other benefits.

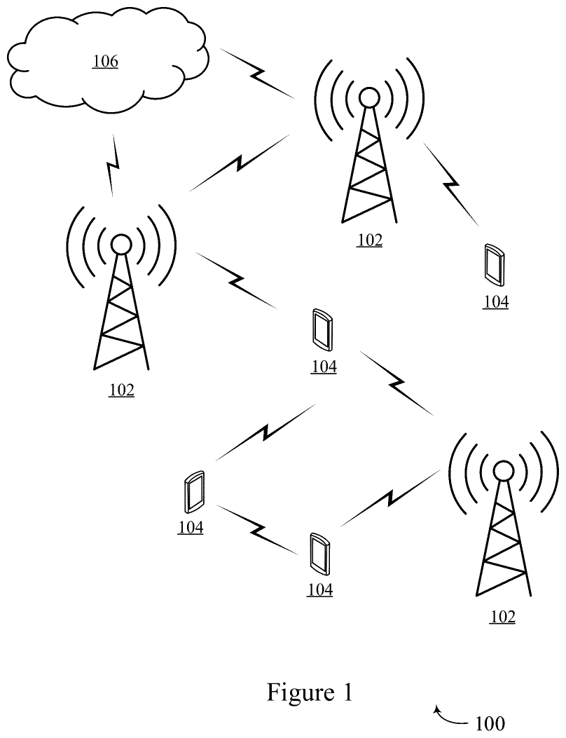

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHZ-114.25 GHz), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., p=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a new or enhanced SSB design or structure enables the transmission of SSBs having adjacent SSSs (e.g., SSS in adjacent or proximate symbols) while reducing issues that arise from cross-correlation between signals or other false alarm scenarios.

In some cases, the SSB structures described herein may be implemented by a cell (e.g., a base station, such as a gNB, eNodeB or other NE 102) having an XL MIMO configuration or other configuration suitable to be deployed as a 6G radio access technology. The cell may have a large antenna array size (e.g., 1024 antenna elements). The large antenna array size may also introduce farfield, nearfield, and/or frequency dependent/beam squinting effects, along with carrier bandwidths in the 7 to 24 GHz spectrum and/or a mmWave spectrum (e.g., above 28 GHz).

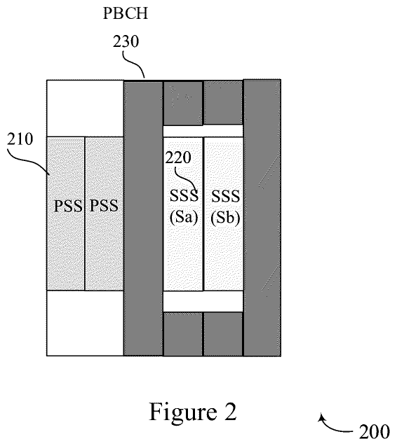

FIG. 2 illustrates an example of an SSB 200 structure in accordance with aspects of the present disclosure. The SSB structure 200 has six OFDM symbols. For example, in a time domain, the SSB structure 200 (e.g., an SS/PBCH block) includes six OFDM symbols (e.g., numbered in increasing order from 0 to 5), where two PSSs 210, two SSSs 720, and PBCH 730, with associated demodulation reference signals (DM-RS), are mapped to the six OFDM symbols of the SSB 200.

Table 1 presents an example mapping to the six OFDM symbols of the SSB 200:

TABLE 1

| | OFDM symbol number l | Subcarrier number k |
|---|---|---|
| Channel | relative to the start | relative to the start |
| or signal | of an SS/PBCH block | of an SS/PBCH block |
| PSS | 0 | 56, 57, . . . , 182 |
| PSS | 1 | 56, 57, . . . , 182 |
| SSS | 3 | 56, 57, . . . , 182 |
| SSS | 4 | 56, 57, . . . , 182 |
| Set to 0 | 0, 1 | 0, 1, . . . , 55, 183, 184, . . . , 239 |
| | 3, 4 | 48, 49, . . . , 55, 183, 184, . . . , |
| | | 191 |
| PBCH | 2, 5 | 0, 1, . . . , 239 |
| | 3, 4 | 0, 1, . . . , 47, |
| | | 192, 193, . . . , 239 |
| DM-RS | 2, 5 | 0 + v, 4 + v, 8 + v, . . . , 236 + v |
| for PBCH | 3, 4 | 0 + v, 4 + v, 8 + v, . . . , 44 + v |
| | | 192 + v, 196 + v, . . . , 236 + v |

In a frequency domain, the SSB 200 may include 240 contiguous subcarriers (SCs) (e.g., numbered in increasing order from 0 to 239) as described with respect to Table 1, where the quantities k and/represent the frequency and time indices, respectively, within one SSB. Further, the OFDM symbols containing the PSSs 210 are repeated (e.g., in the first and the second OFDM symbols) and the OFDM symbols containing the SSSs 220 are repeated (e.g., in the fourth and the fifth OFDM symbols).

As described herein, the SSS symbols may be mapped to a Golay sequence pair, where the complementary Golay sequences of the pair are mapped to each SSS 220 of the SSS symbols of the SSB 200. A Golay sequence, in some cases, is a binary complementary sequence (CS) having a property that its out-of-phase aperiodic autocorrelation coefficients sum to zero.

The NE 102 may utilize various procedures or techniques when generating Golay sequence pairs, as follows. As a first example, a complementary Golay sequence pair may be a combination of a base Golay sequence (S_{A}) and a complementary Golay sequence (S_{B}), such that a periodic or an aperiodic auto correlation between the sequences is zero, close to zero, and/or non-diagonal elements are significantly lower compared to the diagonal elements of a matrix:

$${\vert {R}_{{A}_{0}} ( τ ) \vert}^{2} + {\vert {R}_{{B}_{0}} ( τ ) \vert}^{2} = 0 ∀ τ \neq 0$$

Thus, the sum of the outputs for A and B cancels the off-peak and the autocorrelations of A and B cancel, resulting in a very low sidelobe and leaving only a center peak resulting in a low false alarm.

As another example, the NE 102 may generate complementary sequences using linear combinatorial equations, such as where a base sequence is S_{A}=(A+B)/sqrt(2) and its paired sequence is S_{B}=(A−B)/sqrt(2), where the periodic or aperiodic auto correlation leads to zero. For example, the off-peak terms cancel (e.g., in an ideal case where the cross-correlation terms are opposite-signed and cancel) leading to minimized false alarm and/or sidelobe behaviors.

Once generated, the NE 102 (e.g., a transmitter or transmission entity of the SSB 200) may map the base sequence (S_{A}) to one OFDM symbol and the complementary sequence (S_{B}) to another OFDB symbol. As shown in FIG. 2, the NE 102 may map the base sequence S_{A} to the 4^{th} OFDM symbol, which contains the SSS 220, and may map the complementary sequence S_{B} to the 5^{th} OFDM symbol (e.g., an adjacent or consecutive symbol), which also contains the SSS 220.

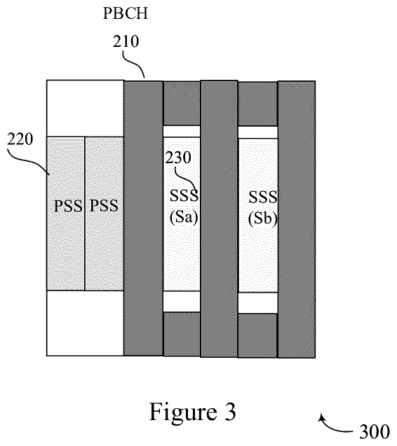

In some examples, the NE 102 may map the Golay sequence pairs to proximate or non-consecutive symbols that contain the SSSs 220. FIG. 3 illustrates an example of an SSB 300 structure in accordance with aspects of the present disclosure. The SSB 300 includes the SSSs 220 in the 4^{th} OFDM symbol and the 6^{th} OFDM symbol (of a 7 symbols SSB 300). The NE 102 maps the base sequence S_{A} to the 4^{th} OFDM symbol, which contains the SSS 220, and may map the complementary sequence S_{B} to the 6^{th} OFDM symbol (e.g., a non-consecutive symbol), which also contains the SSS 220.

Thus, in some examples, the NE 102 may generate multiple SSSs constructed from a complementary Golay sequence pair, map the complementary Golay sequence pair to OFDM symbols allocated for the SSSs, and transmit an SSB that includes OFDM symbols allocated for PSSs, OFDM symbols allocated for PBCH, and the OFDM symbols allocated for the SSSs.

The UE 104 (e.g., a receiver or receiving entity), upon receiving the SSB 200, may detect and correlate the OFDM symbols and then sum the two correlation outputs to form a detection metric.

In some cases, the NE 102 may not generate the Golay sequence pairs using prime numbers and/or lengths being 128, based on the bandwidth of the PSS 210 and SSS 220 in the bandwidth of the SSB 200.

Thus, in some examples, the UE 104 may receive an SSB that includes OFDM symbols allocated for PSSs, OFDM symbols allocated for SSSs, and OFDM symbols allocated for PBCH, where the SSSs are constructed from a complementary Golay sequence pair and detect a first SSS and a second SSS from the complementary Golay sequence pair.

As described herein, the NE 102 (or another transmitter or network entity) may generate the Golay sequence pairs using a variety of techniques (or combinations of techniques). Example techniques include cyclic shifts, sign flips or sign reversals, convolution with Barker sequences, concatenations, PTM constructions, Hadamard matrix transformations, and so on.

For example, the NE 102 may utilize cyclic shifts when generating Golay sequence pairs. The NE 102 may cyclically shift two sequences by the same amount to preserve their complementarity, providing 128 new Golay pairs for a length-128 sequence. In some cases, the NE 102 may apply a phase shift to provide 128 new Golay pairs for a length-128 sequence.

As another example, the NE 102 may utilize sign flips or sign reversals when generating Golay sequence pairs. The NE 102 may negate the A sequence, the B sequence, or both, to generate variants of complementary pairs. For example, use of a Sylvester construction builds longer Golay pairs by recursively combining a shorter one: (A, B), (−A, B), (A, −B), (−A, −B) are complementary and provide four times the variants. In an example implementation, the NE 102 may start with A₀=[1], B₀=[1], iterate seven times (to get length 128=2⁷): A_{k+1}=[A_k B_k], B_{k+1}=[A_k-B_k], and realize a result of A and B being 128-length complementary sequences, such that iteration 0: A=[1] B=[1], iteration 1: A=[1 1] B=[1 −1], iteration 2: A=[1 1 1 −1] B=[1 −1 1 1], iteration 3: A=[1 1 1 −1 1 −1 −1 1] B=[ . . . ], . . . , iteration 7: A=[128 symbols] B=[128 symbols].

As another example, the NE 102 may utilize convolution (e.g., via Barker sequences) when generating Golay sequence pairs. Given a small Barker sequence (e.g., a length-2 Barker sequence: P=[1, 1] and Q=[1, −1] and/or a length-4 Barker sequence: P=[1, 1, 1, −1] and Q=[1, 1, −1, 1]), when a Golay pair is (A, B), the Barker sequence is P, Q. Then, convolution between P and Q may generate Golay pairs, with a length of the final sequence is increased as L_{F}=L_{G}+L_{B}−1, where:

$$A = {A}_{0} * P + {B}_{0} * Q , B = {A}_{0} * Q - {B}_{0} * P$$

As another example, the NE 102 may utilize concatenation when generating Golay sequence pairs. When Golay pairs (A,B) and (C,D) are complementary, then pairs such as (A,C) and (B,D) are also complementary, and may be used as the Golay sequence pairs.

As another example, the NE 102 may utilize phase rotations when generating Golay sequence pairs. The NE 102 may either multiply an A sequence, a B sequence, or both by a constant phase to provide Golay pairs having 16× more variants, such that:

$${A}^{′} = A {e}^{j {ϕ}_{1}} , {B}^{′} = B {e}^{j {ϕ}_{2}}$$

As another example, the NE 102 may utilize transforms when generating Golay sequence pairs. The NE 102 may use a Hadamard matrix, where each row provides one Golay sequence. In some cases, the NE 102 may obtain a Golay pair by splitting a Walsh-Hadamard row into two halves, where their autocorrelations cancel because Hadamard rows have zero off-peak energy. For example, a Hadamard matrix of order 2ⁿ (e.g., Sylvester construction) is defined recursively as:

$${H}_{2 N} = [ {H}_{N} {H}_{N} {H}_{N} - {H}_{N} ]$$

The NE 102 may obtain a Golay complementary pair containing (A, B) from splitting the Hadamard row of 2N into first and second halves, where Aₖ=hₖ (1: N) and Bₖ=hₖ (N+1:2N). In some cases, the NE 102 may use part of a cell identifier (ID) to select a unique row of the Hadamard matrix, such that it provides orthogonal encoding for different network ID (NID) values (e.g., NID1 values) and each phase_idx has a unique modulation pattern to preserve a complementary correlation property phase_idx=mod (NID1, 112) generating 112 unique phases, Thus, H=hadamard (128) generating 128×128 Hadamard matrix, walsh_code=H [phase_idx, :] where selecting one row A_encoded=A.*walsh_code, where, Element-wise multiply B_encoded=B.*walsh_code.

In another example, the NE 102 perform the following steps: step 1, PSS detection, where the NE 102 finds NID2 (0, 1, or 2), step 2, SSS detection, where the NE 102 finds NID1 (0 to 335), and step 3, where the NE 102 calculates a physical cell identity as PCI=3×NID1+NID2 to obtain a total of PCIs: 1008 (336×3).

In some examples, the NE 102 may cyclically shift the base Golay sequence pairs (A, B) using cyclic shifts, m₀ and m₁, where the cyclically shifted Golay sequence pairs (e.g., the sequences of each pair) satisfy the complementary pair criteria described herein. For example, circshift (A, s) indicates a rotatation of the vector A by s samples to generate unique Golay pairs (A, B) for each Nₚₛₛ and Nₛₛₛ, such that:

$${A}_{( {N}_{PSS} , {N}_{SSS} )} = circshift ( {A}_{0} , {m}_{0} ) , {B}_{( {N}_{PSS} , {N}_{SSS} )} = circshift ( {B}_{0} , {m}_{1} ) .$$

In some examples, within 5G, generating cyclic shifts using m₀ and m₁ to generate a Golay pair may include the following parameters: N_{PSS} €{0, 1, 2}, N_{SSS}€{0, 1, . . . , 335}, a physical cell ID (PCID)=3*N_{SSS}+N_{PSS}, m₀=[N_{SSS}/112, and m₁=N_{PSS} mod 112. In some cases, a part of the PCID may be used to select a sequence from a Hadamard matrix.

In some examples, the NE 102 may utilize longer sequences segmented to two SSS symbols when constructing the SSSs (e.g., the SSSs 220). For example, the NE 102 may generate longer m-sequences (e.g., with length of 2×127) and transmit the longer sequences in multiple SSS symbols. The NE 102 may map the sequence to resource elements (REs) from the first SSS symbol, such as from a lowest RE to a highest RE, and continue the remaining sequences in the second SSS symbol from the lowest RE to the highest RE.

In some examples, the NE 102 may utilize an SSB having more SSS symbols than PSS symbols. For example, an SSB may have 2 SSS symbols (e.g., the SSB 200) 4 SSS symbols, 6 SSS symbols, and so on (e.g., in multiples of two). The selection of the number of SSS symbols may be based on reliability requirements for PSS/SSS detection, and as described herein, SSS symbols may be consecutive or non-consecutive within an SSB.

For example, the non-consecutive SSS symbols may be located between the PBCH symbols within an SSB (e.g., as depicted by SSB 300). As another example, the reliability requirements of PBCH may be different compared to the requirements for the PSS or the SSS, and the number of PBCH repeated symbols or the number of PBCH repetitions may be different compared with the PSS and SSS repeated symbols within an SSB. Thus, the number of PSS, SSS, and/or PBCH, repeating within an SSB, may be different, depending on the reliability requirements for each channel.

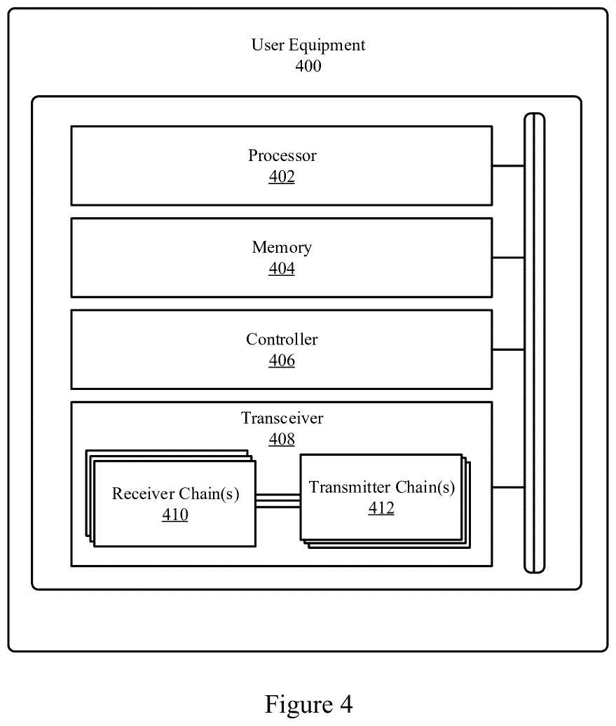

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

For example, the processor 402 may support wireless communication at the UE 400 in accordance with examples as disclosed herein. The NE 400 may be configured to support a means for receiving an SSB that includes OFDM symbols allocated for PSSs, OFDM symbols allocated for SSSs, and OFDM symbols allocated for PBCH, wherein the SSSs are constructed from a complementary Golay sequence pair, and detecting a first SSS and a second SSS from the complementary Golay sequence pair.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 600 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 600 to perform one or more of the functions described herein (e.g., executing, by the processor 402, instructions stored in the memory 404). For example, the processor 402 may support wireless communication at the UE 400 in accordance with examples as disclosed herein.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

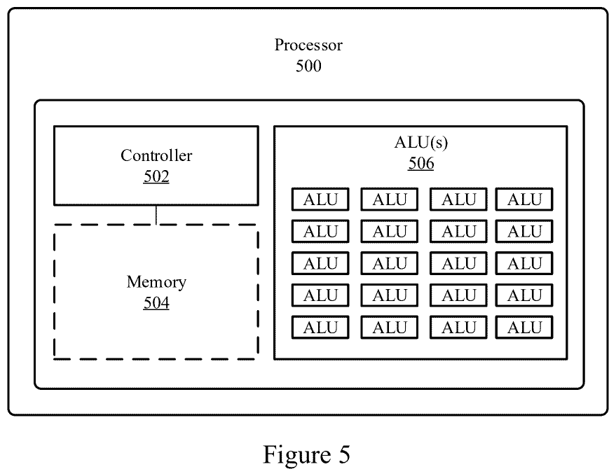

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for receiving an SSB that includes OFDM symbols allocated for PSSs, OFDM symbols allocated for SSSs, and OFDM symbols allocated for PBCH, wherein the SSSs are constructed from a complementary Golay sequence pair, and detecting a first SSS and a second SSS from the complementary Golay sequence pair.

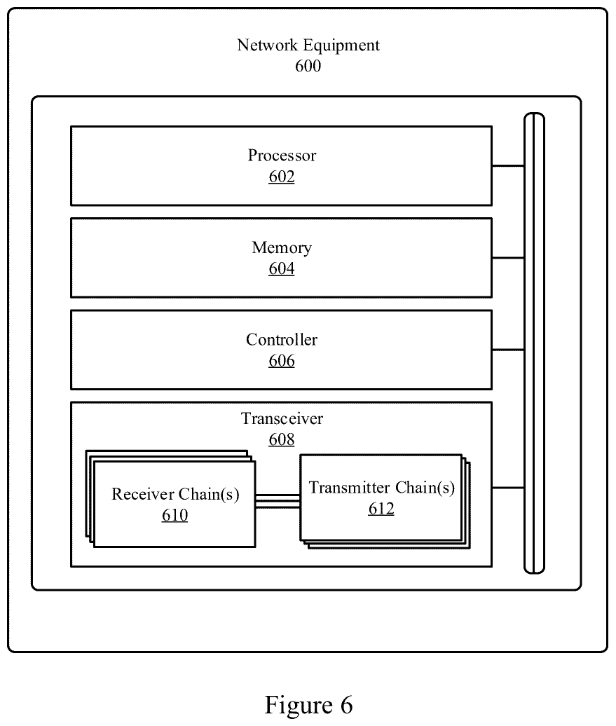

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604).

For example, the processor 602 may support wireless communication at the NE 600 in accordance with examples as disclosed herein. The NE 600 may be configured to support a means for generating multiple SSSs constructed from a complementary Golay sequence pair, mapping the complementary Golay sequence pair to OFDM symbols allocated for the SSSs; and transmitting an SSB that includes OFDM symbols allocated for PSSs, OFDM symbols allocated for PBCH, and the OFDM symbols allocated for the SSSs.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

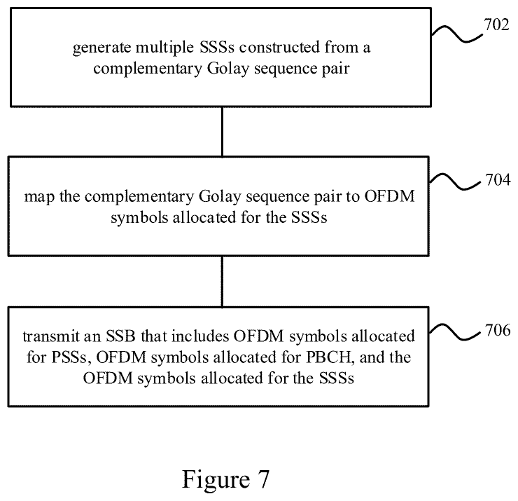

FIG. 7 illustrates a flowchart of a method in accordance with aspects of the present disclosure. The operations of the method may be implemented by an NE as described herein. In some implementations, the NE may execute a set of instructions to control the function elements of the NE to perform the described functions.

At 702, the method may include generating multiple SSSs constructed from a complementary Golay sequence pair. The operations of 702 may be performed in accordance with examples as described herein. In some implementations, aspects of the operations of 702 may be performed by an NE as described with reference to FIG. 6.

At 704, the method may include mapping the complementary Golay sequence pair to OFDM symbols allocated for the SSSs. The operations of 704 may be performed in accordance with examples as described herein. In some implementations, aspects of the operations of 704 may be performed by an NE as described with reference to FIG. 6.

At 706, the method may include transmitting an SSB that includes OFDM symbols allocated for PSSs, OFDM symbols allocated for PBCH, and the OFDM symbols allocated for the SSSs. The operations of 706 may be performed in accordance with examples as described herein. In some implementations, aspects of the operations of 706 may be performed by an NE as described with reference to FIG. 6.

It should be noted that the method described herein describes a possible implementation, and that the operations and the steps may be rearranged or otherwise modified and that other implementations are possible.

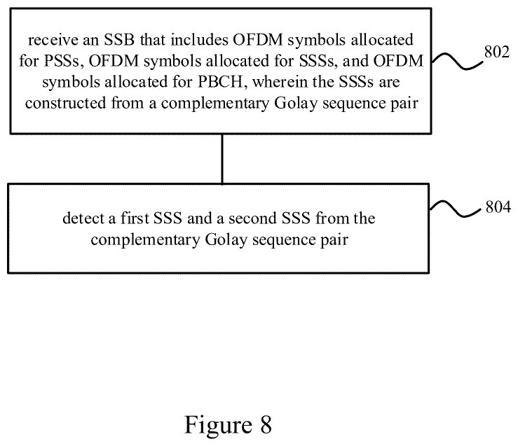

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving an SSB that includes OFDM symbols allocated for PSSs, OFDM symbols allocated for SSSs, and OFDM symbols allocated for PBCH, wherein the SSSs are constructed from a complementary Golay sequence pair. The operations of 802 may be performed in accordance with examples as described herein. In some implementations, aspects of the operations of 802 may be performed by a UE as described with reference to FIG. 4.

At 804, the method may include detecting a first SSS and a second SSS from the complementary Golay sequence pair. The operations of 804 may be performed in accordance with examples as described herein. In some implementations, aspects of the operations of 804 may be performed by a UE as described with reference to FIG. 4.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
generate multiple secondary synchronization signals (SSSs) constructed from a complementary Golay sequence pair;
map the complementary Golay sequence pair to orthogonal frequency-division multiplexing (OFDM) symbols allocated for the SSSs; and
transmit a synchronization signal block (SSB) that includes OFDM symbols allocated for primary synchronization signals (PSSs), OFDM symbols allocated for a physical broadcast channel (PBCH), and the OFDM symbols allocated for the SSSs.

2. The network entity of claim 1, wherein the complementary Golay sequence pair includes a base Golay sequence mapped to an OFDM symbol allocated for a first SSS and a complementary Golay sequence mapped to an OFDM symbol allocated for a second SSS.

3. The network entity of claim 2, wherein the OFDM symbol allocated for the first SSS is a fourth symbol of the SSB and the OFDM symbol allocated for the second SSS is a fifth symbol of the SSB.

4. The network entity of claim 2, wherein the OFDM symbol allocated for the first SSS is a fourth symbol of the SSB and the OFDM symbol allocated for the second SSS is a sixth symbol of the SSB.

5. The network entity of claim 1, wherein the complementary Golay sequence pair includes a first Golay sequence and a second Golay sequence having a periodic or an aperiodic auto correlation that is zero or close to zero.

6. The network entity of claim 1, wherein the complementary Golay sequence pair includes a first Golay sequence and a second Golay sequence that satisfy a complementary check using cyclic shifts.

7. The network entity of claim 1, wherein the complementary Golay sequence pair is a linear combinatorial of a base Golay sequence and complementary Golay sequence.

8. The network entity of claim 1, wherein the complementary Golay sequence pair is generated using cyclic shifts.

9. The network entity of claim 1, wherein the complementary Golay sequence pair is generated using sign flips or sign reversals.

10. The network entity of claim 1, wherein the complementary Golay sequence pair is generated using convolution with Barker sequences.

11. The network entity of claim 1, wherein the complementary Golay sequence pair is generated using concatenations.

12. The network entity of claim 1, wherein the complementary Golay sequence pair is generated using a Prouhet-Thue-Morse (PTM) construction.

13. The network entity of claim 1, wherein the complementary Golay sequence pair is generated using Hadamard matrix transformations.

14. A user equipment (UE) for wireless communication, comprising:
at least one memory; and
at least one processor coupled with the at least one memory and configured to cause the UE to:
receive a synchronization signal block (SSB) that includes orthogonal frequency-division multiplexing (OFDM) symbols allocated for primary synchronization signals (PSSs), OFDM symbols allocated for secondary synchronization signals (SSSs), and OFDM symbols allocated for a physical broadcast channel (PBCH),
wherein the SSSs are constructed from a complementary Golay sequence pair; and
detect a first SSS and a second SSS from the complementary Golay sequence pair.

15. The UE of claim 14, wherein a base Golay sequence is mapped to an OFDM symbol allocated for the first SSS and a complementary Golay sequence is mapped to an OFDM symbol allocated for a second SSS.

16. The UE of claim 15, wherein the OFDM symbol allocated for the first SSS is a fourth symbol of the SSB and the OFDM symbol allocated for the second SSS is a fifth symbol of the SSB.

17. The UE of claim 15, wherein the OFDM symbol allocated for the first SSS is a fourth symbol of the SSB and the OFDM symbol allocated for the second SSS is a sixth symbol of the SSB.

18. The UE of claim 14, wherein the complementary Golay sequence pair includes a first Golay sequence and a second Golay sequence having a periodic or an aperiodic auto correlation that is zero or close to zero.

19. A method performed by a network entity, the method comprising:
generating multiple secondary synchronization signals (SSSs) constructed from a complementary Golay sequence pair;
mapping the complementary Golay sequence pair to orthogonal frequency-division multiplexing (OFDM) symbols allocated for the SSSs; and
transmitting a synchronization signal block (SSB) that includes OFDM symbols allocated for primary synchronization signals (PSSs), OFDM symbols allocated for a physical broadcast channel (PBCH), and the OFDM symbols allocated for the SSSs.

20. A method performed by a user equipment (UE), the method comprising:
receiving a synchronization signal block (SSB) that includes orthogonal frequency-division multiplexing (OFDM) symbols allocated for primary synchronization signals (PSSs), OFDM symbols allocated for secondary synchronization signals (SSSs), and OFDM symbols allocated for a physical broadcast channel (PBCH),
wherein the SSSs are constructed from a complementary Golay sequence pair; and
detecting a first SSS and a second SSS from the complementary Golay sequence pair.
